(19) United States
(12) Patent Application Publication
(10) Pub. No.: US 2017/0023665 A1
(43) Pub. Date: Jan. 26, 2017

(54) Integrative Multi-sensor Lidar Scanning System

(71) Applicant: Beijing GreenValley Technology Co., Ltd., Beijing (CN)

(72) Inventor: Yanming Guo, B (CN)

(73) Assignee: Beijing GreenValley Technology Co., Ltd., Beijing (CN)

(21) Appl. No.: 15/141,004

(22) Filed: Apr. 28, 2016

(30) Foreign Application Priority Data
Jul. 20, 2015 (CN) 201520524626.2

(51) Int. Cl. G01S 7/48; G01S 19/31; G01C 21/16; G01S 17/42

(52) U.S. Cl. CPC G01S 7/4808; G01S 17/42; G01S 19/31; G01C 21/165

(57) ABSTRACT

An integrative multi-sensors Lidar scanning system includes GPS, Lidar sensor, inertial measurement unit and control and storage system; POS system is used to acquire pose and coordinate position and realize time synchronization of the system; control and storage system is produced by integrated development based on low-power development board, which is used to store the collected data and communicate with ground station through wireless network; it could also include one or several external sensors; the parts described above are all fixed on mounting rack to form the integrative multi-sensors Lidar scanning system, and the system connects to platform through the mounting rack. This system is small in size, light in weight and low in power consumption; it is of higher stability and security; it is more convenient for the users to acquire various remote sensing data; it can be widely applied to the 3D data acquisition field.

### CROSS-REFERENCE TO RELATED APPLICATIONS

This application claims the right of priority of Chinese patent application 201520524626.2, filed Jul. 20, 2015.

### FIELD OF THE INVENTION

The present invention relates to remote sensing data acquisition systems, especially an integrative multi-sensor Lidar scanning system used to acquire a variety of remote sensing data.

### BACKGROUND OF THE INVENTION

Remote sensing data is in demand in civil application field such as city, forestry, ecology, vegetation, disaster assessment, emergency response and topographic mapping. Mobile remote sensing system has the advantages of small size, light weight, low cost, low loss, reusability and low risk, with its applicable scope expanding from military field to non-military field. Unmanned remote sensing has high real-time and high resolution features that conventional satellite remote sensing can't match so that it has become more and more popular among researchers and manufacturers. Making the applicable domain and user group in remote sensing expand, unmanned remote sensing has broad application prospect.

Mobile remote sensing system mainly includes sensor scanning remote sensing system and mobile platform for loading sensors. Now the sensors scanning remote sensing system integrates such technologies as Global Positioning System (GPS), inertial measurement unit (IMU), image processing, photogrammetry, geographic information and integrative control. Currently mobile remote sensing system is important for acquiring remote sensing data since it makes it possible that the measurement on space coordinate is on demand through collecting spatial information and real images, and determining measured parameters like the position of real images by satellite and inertial positioning. However, current sensor systems have the following problems: 1. Most sensor systems are large and heavy so that sensor loading platform's battery life is short. 2. Sensor system is not able to acquire the remote sensing data of sufficient density and precision. 3. Sensor system is not of high stability and security.

Therefore, current sensor scanning remote sensing systems can't satisfy the various needs in practical use.

### BRIEF SUMMARY OF THE INVENTION

The present invention is an integrative multi-sensors Lidar scanning system, comprising a control and storage system formed through integrated development of low-power development board; an inertial measurement unit; a Global Positioning System, the Global Positioning System connected to an antenna interface of the inertial measurement unit by an antenna feeder; a Lidar sensor; and a mounting rack. The control and storage system, the inertial measurement unit, the Global Positioning System, and the Lidar sensor interconnect with each other and are mounted on a platform through the mounting rack. The integrative multi-sensors Lidar scanning system of can further comprises one or more external sensors connected to the control and storage system. The one or more external sensors are sensors selected from the group consisting of hyper-spectral cameras, multi-spectral cameras and common cameras.

The mounting rack of the integrative multi-sensors Lidar scanning system comprises a bottom plate with a fixed interface for the inertial measurement unit, a fixed interface for the control and storage system, a fixed interface for the Lidar sensor, and a fixed interface for the external sensor; a top plate; a fixed rail attached to the top plate, one end of the fixed rail protruding out of the top plate, wherein the Global Positioning System is installed at the end of the fixed rail protruding out of the top plate; and at least one joint lever attached to the bottom plate and to the top plate. The fixed rail is about 40 cm long. The inertial measurement unit is installed on and above the bottom plate, and the control and storage system and the Lidar sensor are installed on and under the bottom plate. In one embodiment, the inertial measurement unit is installed above the Lidar sensor.

The platform is a platform selected from the group consisting of unmanned helicopters, multi-rotor unmanned aircraft systems, fixed-wing unmanned aircraft systems, automobiles, ship or knapsacks.

The control and storage system of the integrative multi-sensors Lidar scanning system comprises a shell covering the control and storage system; a power supply system providing power for the integrative multi-sensors Lidar scanning system; a memory card storing data collected by the Lidar sensor and the inertial measurement unit; a development board controlling the Lidar sensor and the inertial measurement unit; a connection interface for the inertial measurement unit; and a connection interface for the Lidar sensor. In one embodiment, the control and storage system is integratively developed based on XILINX embedded DK-V6-EMBD-G development board. The connection interface for the inertial measurement unit is a COM port, and the connection interface for the Lidar sensor is a network interface. The shell is titanium alloy. In one embodiment, the size of the integrative multi-sensors Lidar scanning system is 220×120×100 mm; its power consumption is 40 w and the total weight is not more than 3 kg.

### BRIEF DESCRIPTION OF THE DRAWINGS

FIG. 1 is a diagram of an integrative multi-sensor Lidar scanning system, according to some embodiments.

FIG. 2 is a diagram of a mounting rack and its connections, according to some embodiments.

### DETAILED DESCRIPTION OF THE INVENTION

With the aim of overcoming the technological disadvantages presented above, the present invention provides a multi-sensor Lidar scanning system used to quickly acquire various remote sensing data including Lidar point cloud data of high density and high precision; this system includes a GPS, a Lidar sensor, an inertial measurement unit (IMU) and a control and storage system, and may be also includes one or more external sensors; the control and storage system is produced through integrated development based on low power development board; the system has compact structure; it's very small in size, light in weight and low in power consumption; it can provide longer battery life for its platform; it is of higher stability and security.

The technical proposal provided in the present invention is as below.

An integrative multi-sensor Lidar scanning system including a GPS, a Lidar sensor, an inertial measurement unit and a control and storage system; the GPS is interconnected with the inertial measure unit's antenna interface through an antenna feeder; the inertial measurement unit, the control and storage system and the Lidar sensor interconnect with each other; the inertial measurement unit is used to capture pose and coordinate position, and to realize the time synchronization of the control and storage system and the Lidar sensor; the integrative multi-sensor Lidar scanning system could also include one or more external sensors, which connect to the control and storage system; the control and storage system is formed through integrated development of low-power development board, which is used to store the data collected by sensors and communicate with ground station by wireless networks; the GPS, the Lidar sensor, the inertial measurement unit, the control and storage system and the one ore more external sensors described above were all installed on a mounting rack, forming the integrative multi-sensor Lidar scanning system; moreover, the integrative multi-sensor Lidar scanning system was linked to a platform through the mounting rack.

In the present invention, the mounting rack includes a bottom plate, a top plate, at least one joint lever between the bottom plates and the top plate, and a fixed rail. The bottom plate of the mounting rack is equipped with a fixed interface for the inertial measurement unit, a fixed interface for the control and storage system, a fixed interface for the Lidar sensor and at least one fixed interface for the at least one external sensors, while the top plate is equipped with a platform interface. The inertial measurement unit, the control and storage system and the Lidar sensor are all installed in the corresponding fixed interfaces on the bottom plate of the mounting rack by fasteners. One end of the fixed rail is aligned with one edge of the top plate and the other end protrudes out of the top plate. The GPS is installed at the end of the fixed rail protruding out of the top plate. The fixed rail is about 40 cm long. The inertial measurement unit is installed on and above the bottom plate. There are four joint levers between the top plate and the bottom plate. The control and storage system and the Lidar sensor are both installed on and under the bottom plate. The inertial measurement unit is placed above the Lidar sensor to form the integrated design, so that the integrative multi-sensor Lidar scanning system has a more compact structure and saves a lot of space. The overall size of the integrative multi-sensor Lidar scanning system is 220×120×100 mm. Its power consumption is 40 w. The total weight is not more than 3 kg.

The integrative multi-sensor Lidar scanning system is connected by fasteners to the platform through a platform interface in the mounting rack. The platforms can be an unmanned helicopter, a multi-rotors unmanned aircraft system, a fixed-wing unmanned aircraft system, an automobile, a ship or a knapsack, making it convenient for users to acquire data.

The control and storage system is produced through integrated development of low-power development board, therefore the overall power consumption of the system is low and the size of the system is small. In the integrative multi-sensor Lidar scanning system, the control and storage system includes a shell, a development board, a memory card, a power supply system and connection interfaces (COM port and network interface); the power supply system is place inside the control and storage system to provide power for all equipments including the IMU, the Lidar sensor and the development board, etc. The development board controls the Lidar sensor, the time when IMU starts to collect data and working state, etc. The data collected by the Lidar sensor and the inertial measurement unit is delivered back to the development board and stored and recorded in memory card. The control and storage system connects to the inertial measurement unit through COM port and connects to the Lidar sensor through network interface. The control and storage system communicates with a ground station through wireless network to transmit data to the ground station. In the present invention, the integrated development of control and storage system is based on XILINX embedded DK-V6-EMBD-G development board. The control and storage system is placed in the shell of the control and storage system, and the material of shell is titanium alloy of light weight and high hardness.

The Inertial Measurement Unit (IMU) consists of highly precise three-axis gyroscope and accelerometers at three directions of the coordinate. It is the datum center of the whole Lidar system, and its major advantage is that even if without external reference, it can also acquire real-time pose and coordinate position. In one embodiment of the present invention, the IMU is Novatel S1. The Lidar sensor could be selected from brands like Riegl, Optech or Velodyne; the preferred option is velodyne 16E which is lighter than others so that the integrative multi-sensor Lidar scanning system is lighter and more portable.

The one or more external sensors could be hyper-spectral cameras, multi-spectral cameras and common cameras; the one or more external sensors are interconnected with the control and storage system so that the data collected by the one or more external sensors can be transmitted to the control and storage system and be stored and recorded; the one or more external sensors could also be interconnected with the IMU and the IMU enables the time synchronization between the control and storage system and the one or more external sensors.

Compared to prior technology, the present invention has these beneficial effects.

The present invention provides an integrative multi-sensor system for acquiring various remote sensing data, composed of a highly precise IMU, a control and storage system, a Lidar sensor and a GPS. The system is highly integrated and very portable. The POS system (GPS and IMU), the control and storage system and the Lidar sensor (the external sensors, if present) are interconnected with each other; POS system is used to acquire real-time pose and coordinate position, and realize the time synchronization between the control and storage system and the Lidar sensor (the external sensor, if present); the control and storage system communicates with the ground station through wireless network. The present invention is produced by integrated development based on low-power development board, so that the size of the system is small and the power consumption of the system is low. The total weight of this system is not more than 3 kg. The system can be installed on unmanned helicopters, multi-rotors unmanned aircraft systems, fixed-wing unmanned aircraft systems, as well as automobiles, ships and knapsacks, etc. It's convenient for users to quickly acquire various remote sensing data including Lidar point cloud data of high density and high precision. The system has a compact structure; it's small in size, light in weight and low in power consumption; it provides longer battery life for the platform; it is more stable and more safe; it can be applied in the 3D application domains such as city, forestry, ecology, vegetation, disaster emergency and terrain, etc.

### BEST MODE

With reference to figures, in this part the author give further description of the present invention through the embodiment without setting any limitation on the scope of the present invention.

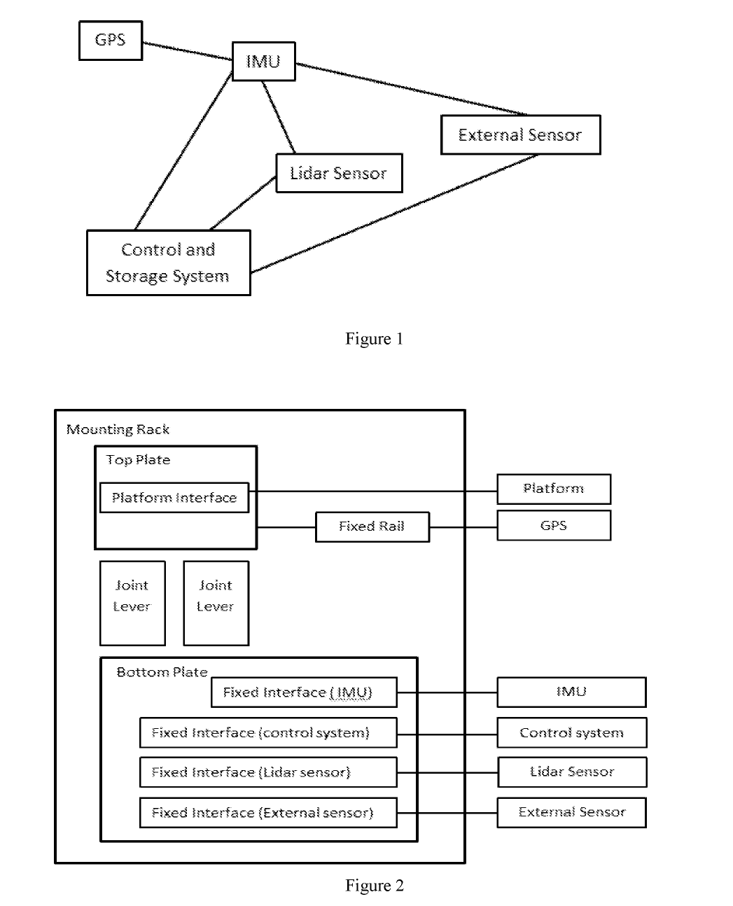

The present invention provides an integrated multi-sensor Lidar scanning system. FIG. 1 is a diagram of the integrative multi-sensor Lidar scanning system, according to this embodiment, including a GPS, a Lidar sensor, an IMU and a control and storage system; and it could also include one or more external sensors.

In the integrative multi-sensor Lidar scanning system, the GPS connects with the TNC of IMU by antenna feeder. The IMU, the control and storage system and the Lidar sensor (or external sensors, if present) are interconnected with each other. The IMU enables the time synchronization between the control and storage system and the Lidar sensor (or external sensors, if present). The IMU consists of highly precise three-axis gyroscope and the accelerometers at three directions of the coordinate. It is the datum center of the whole Lidar system, and its major advantage is that even if without external reference, it can also acquire real-time pose and coordinate position. In this embodiment of the present invention, the IMU is Novatel S1.

Taking advantage of the rapidly rotating laser head for highly frequent ranging, Lidar sensor constantly keeps records of the ranging data from different directions so that gets 3D coordinate information on the basis of scanning center. Given that the Lidar sensor don't need to collect the data located above the Lidar, the present invention put the IMU on top of the Lidar sensor to complete the integrative design. Therefore, the integrative multi-sensor Lidar scanning system is more compact in structure, saving a lot of space.

The control and storage system communicates with a ground station through wireless network. The control and storage system is produced by integrated development based on low-power development board. The control and storage system includes a shell, a development board, a memory card, a power supply system and connection interfaces (COM port and network interface). The power supply system is placed inside the control and storage system, which provides power for all equipments including the IMU, the Lidar sensor and the development board, etc. The development board controls the Lidar sensor and the time when the IMU starts to collect data as well as the operating status. The data collected by the Lidar sensor and the inertial measurement unit is delivered back to the development board and stored and recorded in the memory card. In this embodiment, the integrated development of the control and storage system is based on XILINX embedded DK-V6-EMBD-G development board. The control and storage system connects to the inertial measurement unit through COM port and connects to the Lidar sensor through network interface. The control and storage system is placed in the shell of the control and storage system. The material of the shell is titanium alloy of light weight and high hardness.

The one or more external sensors could be several types of sensors, such as hyper-spectral cameras, multi-spectral cameras and common cameras. The one or more external sensors can connect to the control and storage system through a network interface using a connection wire. The one or more external sensors can also connect to the IMU, which enables the time synchronization between the one or more external sensors and the control and storage system.

FIG. 2 is a diagram of a mounting rack and its connections, according to this embodiment. When installing the integrated multi-sensor Lidar system, the GPS, the Lidar sensor, the IMU, the control and storage system and the one or more external sensors are installed on and connected by the mounting rack. In this embodiment, the mounting rack includes a bottom plate, a top plate, at least one joint lever attached to the bottom plate and to the top plate, and a fixed rail attached to the top plate. The fixed rail is about 40 cm long. One end of the fixed rail is aligned with one edge of the top plate and the other end protrudes out of the top plate. A fixed interface for the inertial measurement unit, a fixed interface for the control and storage system, a fixed interface for the Lidar sensor and fixed interfaces for one or more external sensors are located on the bottom plate of the mounting rack. A platform interface is located on the top plate of the mounting rack. The IMU, the control and storage system and the Lidar sensor are all installed in the corresponding fixed interfaces of the mounting rack by fasteners. The GPS is installed at the end of the fixed rail protruding out of the top plate. In this embodiment, the GPS connects to the IMU by a antenna feeder placed above the whole system to make sure that it receive signal effectively. The IMU is installed on and above the bottom plate. There are four joint levers between the top plate and the bottom plate. The control and storage system and the Lidar sensor are both installed on and under the bottom plate. The control and storage system is to the left of the Lidar sensor. The mounting rack contains fixed interfaces for the one or more external sensors; the one or more external sensors are linked to the mounting rack through the fixed interface for the one or more external sensors. The one or more external sensors, if present, are installed to the right of the Lidar sensor.

Fasteners (for example, screws) are used to connect the multi-sensor Lidar scanning system to the platform through the platform interface on the mounting rack. The installation process, which can be completed simply by twisting the screw, is very easy. The platform can be unmanned helicopters, multi-rotors unmanned aircraft systems, or fixed-wing unmanned aircraft systems; it can also be installed on such carriers as automobiles, ships and knapsacks. These platform makes it convenient for users to acquire data.

In this embodiment, the integrated multi-sensor Lidar scanning system integrates a highly precise IMU, a control and storage system, a Lidar sensor and a GPS. Its overall size is 220×120×100 mm. The power consumption is 40 w and the total weight is not more than 3 kg (total weight is 2.6 kg). Highly integrated, portable and stable, it is the smallest, lightest and consuming the least power among all the current unmanned helicopter Lidar scanning systems. Moreover, it can be installed on many types of platforms according to different needs. Unmanned helicopter is sensitive to weight and power consumption. Lighter weight and lower power consumption bring longer battery life, higher stability and higher security. When this integrative multi-sensor Lidar scanning system is installed on a small light unmanned helicopter platform (customized multi-rotors unmanned aircraft system), the total weight of the helicopter is not more than 10 kg. When the multi-rotors unmanned aircraft system with the integrative multi-sensor Lidar scanning system is flying at the height of 80 meters, the vertical precision and horizontal precision is at about 20 cm, the width of scanning is about 140 m, the flight speed is 20 km/h, point cloud density is about 100 pts/m², one flight can last for 15-25 minutes and the area covers 0.5 km².

It is worth noticing that the objective of publishing the embodiment is helping to further understand the present invention, but the technicians in this field should know: All kinds of substitution and modification is acceptable as long as not digressing from the spirit and scope of the present invention and its claims. Therefore, the present invention should not be limited to the content uncovered by this embodiment, and the present invention requires that the scope of protection is in accordance with what define in Claims.

1. An integrative multi-sensors Lidar scanning system, comprising:
a control and storage system formed through integrated development of low-power development board;
an inertial measurement unit;
a Global Positioning System, the Global Positioning System connected to an antenna interface of the inertial measurement unit by an antenna feeder;
a Lidar sensor; and
a mounting rack;
wherein the control and storage system, the inertial measurement unit, the Global Positioning System, and the Lidar sensor interconnect with each other and are mounted on a platform through the mounting rack.

2. The integrative multi-sensors Lidar scanning system of claim 1, further comprising one or more external sensors connected to the control and storage system.

3. The integrative multi-sensors Lidar scanning system of claim 2, wherein the one or more external sensors are sensors selected from the group consisting of hyper-spectral cameras, multi-spectral cameras and common cameras.

4. The integrative multi-sensors Lidar scanning system of claim 2, wherein the mounting rack comprises:
a bottom plate with a fixed interface for the inertial measurement unit, a fixed interface for the control and storage system, a fixed interface for the Lidar sensor, and a fixed interface for the external sensor;
a top plate;
a fixed rail attached to the top plate, one end of the fixed rail protruding out of the top plate, wherein the Global Positioning System is installed at the end of the fixed rail protruding out of the top plate; and
at least one joint lever attached to the bottom plate and to the top plate.

5. The integrative multi-sensors Lidar scanning system of claim 4, wherein the fixed rail is about 40 cm long.

6. The integrative multi-sensors Lidar scanning system of claim 4, wherein the inertial measurement unit is installed on and above the bottom plate, and the control and storage system and the Lidar sensor are installed on and under the bottom plate.

7. The integrative multi-sensors Lidar scanning system of claim 6, wherein the inertial measurement unit is installed above the Lidar sensor.

8. The integrative multi-sensors Lidar scanning system of claim 1, wherein the platform is a platform selected from the group consisting of unmanned helicopters, multi-rotor unmanned aircraft systems, fixed-wing unmanned aircraft systems, automobiles, ship or knapsacks.

9. The integrative multi-sensors Lidar scanning system of claim 1, wherein the control and storage system comprises:
a shell covering the control and storage system;
a power supply system providing power for the integrative multi-sensors Lidar scanning system;
a memory card storing data collected by the Lidar sensor and the inertial measurement unit;
a development board controlling the Lidar sensor and the inertial measurement unit;
a connection interface for the inertial measurement unit; and
a connection interface for the Lidar sensor.

10. The integrative multi-sensors Lidar scanning system of claim 9, wherein the control and storage system is integratively developed based on XILINX embedded DK-V6-EMBD-G development board.

11. The integrative multi-sensors Lidar scanning system of claim 9, wherein the connection interface for the inertial measurement unit is a COM port, and the connection interface for the Lidar sensor is a network interface.

12. The integrative multi-sensors Lidar scanning system of claim 9, wherein the shell is titanium alloy.

13. The integrative multi-sensors Lidar scanning system of claim 1, wherein the size of the integrative multi-sensors Lidar scanning system is 220×120×100 mm, the power consumption of the integrative multi-sensors Lidar scanning system is 40 w and the weight of the integrative multi-sensors Lidar scanning system is not more than 3 kg.
